(19) United States
(12) Patent Application Publication
(10) Pub. No.: US 2008/0229587 A1
(43) Pub. Date: Sep. 25, 2008

(54) Grooming Scissors

(75) Inventor: Edward P. Dennis, Conifer, CO (US)

Correspondence Address: MARSH, FISCHMANN & BREYFOGLE LLP, 3151 SOUTH VAUGHN WAY, SUITE 411, AURORA, CO, 80014, US

(73) Assignee: TOPET USA INC., Morrison, CO (US)

(21) Appl. No.: 12/053,200

(22) Filed: Mar. 21, 2008

Related U.S. Application Data
(60) Provisional application No. 60/896,100, filed on Mar. 21, 2007.

(51) Int. Cl. B26B 19/22; B26B 13/00

(52) U.S. Cl. 30/195; 30/233.5

(57) ABSTRACT

Combination grooming scissors that are particularly adapted for the grooming of an animal. The grooming scissors include a hair cutting portion and a hair thinning portion in one device. The thinning portion of the grooming scissors can be disposed nearest the pivot point of the scissors and the cutting portion can be disposed nearest the end tip of the scissors. This enables the scissors to be used to thin the hair of the animal without cutting the hair. The tip of the scissors is advantageously blunt to prevent inadvertent stabbing of the animal during use.

### CROSS-REFERENCE TO RELATED APPLICATIONS

This application claims priority to U.S. Provisional Patent Application Ser. No. 60/896,100 entitled “GROOMING SCISSORS”, filed Mar. 21, 2007, the disclosure of which is incorporated herein by reference in its entirety.

### BACKGROUND OF THE INVENTION

1. Field of the Invention

The present invention relates to grooming scissors that are particularly useful for the grooming of furred animals, such as dogs.

2. Description of Related Art

Two different types of scissors or shears are typically utilized to cut hair, such as the hair of a domestic animal, such as a dog. Thinning scissors are employed to reduce the density of the hair in one or more areas, which allows the remaining hair to more readily lie in a desired position. Thinning scissors typically include cooperating cutting blades where one of the blades is formed with serrations along its length. The other type of scissors typically employed is a standard cutting scissors in which two cooperating blades slidably engage one another with the hair between the blades to cut the hair to a desired length.

When grooming an animal such as a dog, it is important to groom the animal as rapidly as possible since the animal may become restless after a short period of time. Further, animals such as dogs may make sudden and unexpected movements during the grooming process, which can result in the animal being harmed by the blades of the scissors, particularly the sharp tip at the end of the scissors.

It is therefore an object of the present invention to provide grooming scissors that are particularly useful for the grooming of an animal such as a dog. The scissors provide the combined functionality of cutting scissors and thinning scissors and also provide increased safety in the event of sudden movement by the animal being groomed.

### SUMMARY OF THE INVENTION

Accordingly, the present invention provides combination grooming scissors for hair cutting and hair thinning and a method of grooming an animal, such as a dog, using the scissors. The scissors advantageously combine the functions of hair cutting scissors and hair thinning scissors, while also reducing the likelihood that an animal being groomed using the scissors will be injured by the scissors due to a sudden movement made by the animal.

According to one embodiment, grooming scissors are provided that are adapted for the cutting and thinning of hair. The grooming scissors include a first blade, wherein the first blade comprises a base portion that is adapted to be engaged by one or more fingers of a user, and a distal end that is sufficiently blunt to prevent inadvertent stabbing of an animal being groomed. A pivot point is disposed between the base portion and the distal end, and a cutting edge is disposed between the pivot point and the distal end. The grooming scissors also include a second blade that is pivotally connected to the first blade, wherein the second blade comprises a base portion that is adapted to be engaged by one or more fingers of a user, a distal end that is also sufficiently blunt to prevent inadvertent stabbing of an animal being groomed, a pivot point disposed between the base portion and the distal end, a thinning edge portion and a cutting edge portion.

According to one aspect of the invention, the thinning edge portion is proximate to the pivot point and can include a plurality of serrations extending in a direction substantially perpendicular to the edge of the second blade. According to this aspect, the cutting edge portion can advantageously be disposed proximate to the blunt distal end of the second blade.

### DESCRIPTION OF THE DRAWINGS

FIG. 1 illustrates a pair of combination scissors according to an embodiment of the present invention.

FIG. 2 illustrates a pair of combination scissors according to an embodiment of the present invention.

FIGS. 3(a)-3(b) illustrate scissor blades having a sharp end and having a blunt end.

### DESCRIPTION OF THE INVENTION

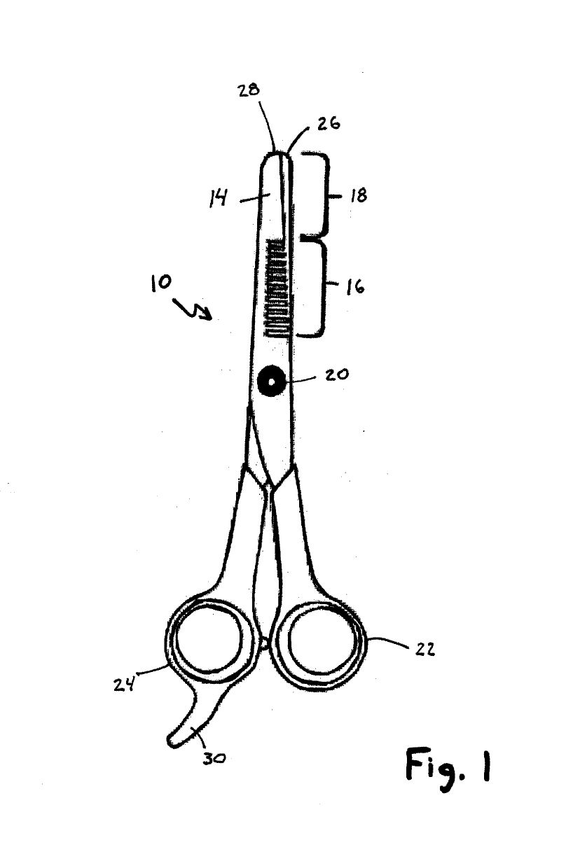

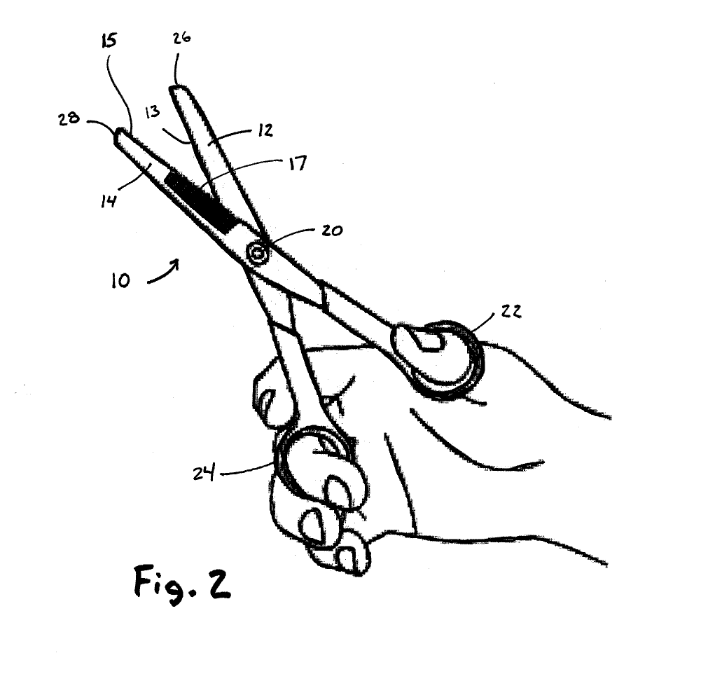

FIGS. 1 and 2 illustrate an embodiment of grooming scissors 10 according to the present invention. The grooming scissors include a pair of opposed blades 12 and 14 that are pivotally attached to each other at a pivot point 20. The first blade 12 includes a base portion 24 that is adapted to be engaged by one or more fingers of a user to operate the scissors 10. For example, the base portion 24 can include an aperture for receiving one or more fingers of a user. The base portion 24 can also include an extension 30 disposed on an outer edge of the base portion 24 that is adapted to be engaged by the finger(s) of a user to provide improved leverage and cutting force when using the grooming scissors 10.

A cutting edge 13 extends along the first blade 12 between the pivot point 20 and a blunt distal end 26 of the first blade 12. The cutting edge 13 can extend along substantially the entire length of the first blade 12 between the pivot point 20 and the blunt end tip 26, or a portion thereof. The cutting edge 13 cooperates with a cutting edge 15 on the second blade 14 to form a cutting portion 18 adapted to cut hair to a desired length.

The blunt end 26 is not pointed, as is common in many scissors, but rather is blunt and obtuse. That is, the distal end of the first blade does not terminate in a sharp pointed end, but rather tapers to terminate in a blunt end that is not capable of piercing the skin of the animal or otherwise causing significant discomfort for the animal if the animal is inadvertently poked with the distal end of the blade. For example, the distal end can be rounded. This feature advantageously prevents inadvertent stabbing of an animal being groomed, such as when the animal makes a sudden and unexpected movement.

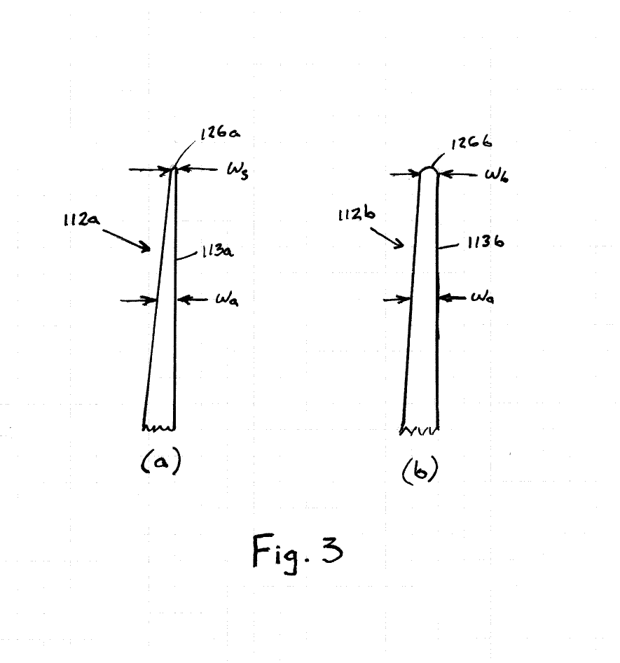

Referring to FIGS. 3a and 3b, an upper portion of two scissor cutting blades is illustrated. The cutting blade 112a illustrated in FIG. 3(a) can be considered a cutting blade having a sharp distal end, whereas the cutting blade 112bt illustrated in FIG. 3(b) can be considered a cutting blade having a blunt distal end. The blade 112a terminates at a distal end 126a that is sharp and pointed, which could cause significant discomfort for an animal being groomed. Thus, the width Wₛ of the distal end 126a (i.e., the width measured where at least one of the two opposed side edges of the blade begins to converge by curving toward the other) is a very small fraction of the average width of the cutting blade taken along its length between the pivot point and the distal end, designated for simplicity in FIG. 3(b) as Wₐ.

In contrast, the cutting blade 112b having a blunt distal end 126b will not cause significant discomfort for an animal if the animal is inadvertently poked with the distal end 126b during grooming. In this regard, the width W_{b} of the distal end 126b, measured where at least one of the two opposed edges of the blade begins to converge by curving toward the other, is a substantial fraction of the average width Wₐ of the blade 112b taken along its length. According to one embodiment, the distal end 126b of the blade 112b has a width W_{b} that is at least about 25 percent, more preferably at least about 50 percent and even more preferably at least about 75 percent of the average width Wₐ of the blade taken over the length of the first blade 112b. In an even more preferred embodiment, the distal end of the first blade has a width that is at least about 90 percent of the average width of the cutting portion of the first blade. Although such widths are preferred to provide a blunt distal end, what is an important aspect of the present invention is that the distal end is sufficiently blunt to prevent discomfort to the animal being groomed.

Referring back to FIG. 1 and FIG. 2, the first blade 12 is pivotally connected to a second blade 14. The second blade 14 includes a base portion 22 that is adapted to be engaged by one or more finger (e.g., a thumb) of a user to operate the scissors 10. The second blade 14 also includes a blunt distal end 28 that is sufficiently blunt to prevent inadvertent stabbing of an animal during the grooming process. In this regard, the foregoing description of the first blade with reference to FIG. 3b is also applicable to the second blade 14. It is an also an aspect of the present invention that the distal ends of each of the blades 12 and 14 are sufficiently blunt to prevent injury to the animal whether in the closed position (FIG. 1) or open position (FIG. 2).

The second blade 14 includes a thinning edge 17 and a cutting edge 15. In the embodiment illustrated in the figures, the cutting edge 15 is disposed closest to the blunt end 28 and the thinning edge 17 is disposed closest to the pivot point 20. In this manner, thinning of an animal's hair can be accomplished using the thinning portion 16 without inadvertently cutting portions of the animal's fur with the cutting portion 18. It will be appreciated that the thinning portion 16 can include serrations that are substantially perpendicular to the edge of the cutting blade 14.

The blades of the grooming scissors according to the present invention can be fabricated from a variety of materials including metal or a hard plastic material.

It is a significant advantage of the present invention that the grooming scissors include the functions of both thinning scissors and cutting scissors in a single instrument. It is also an advantage of the present invention that the ends of the blades are individually blunt and also are blunt when the scissors are in a closed position.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. Grooming scissors that are adapted for the cutting and thinning of hair, comprising:
(a) a first blade, wherein said first blade comprises a first base portion that is adapted to be engaged by one or more fingers of a user, a first distal end that is sufficiently blunt to prevent inadvertent stabbing of an animal being groomed, a first pivot point disposed between said base portion and said blunt end, and a first cutting edge disposed between said pivot point and said first distal end; and
(b) a second blade that is pivotally connected to said first blade at said first pivot point, wherein said second blade comprises a second base portion that is adapted to be engaged by one or more fingers of a user, a second distal end that is sufficiently blunt to prevent inadvertent stabbing of an animal being groomed, a second pivot point disposed between said second base portion and said second distal end, a thinning edge portion and a second cutting edge portion.

2. Grooming scissors as recited in claim 1, wherein said thinning edge portion is disposed proximate to said second pivot point and said second cutting edge portion is disposed proximate to said second distal end.

3. Grooming scissors as recited in claim 1, wherein said thinning edge comprises a plurality of serrations extending in a direction substantially perpendicular to the edge of said second blade.

4. Grooming scissors as recited in claim 1, wherein said first distal end has a width that is at least about 50 percent of the average width of the first blade measured between the first pivot point and the first distal end.

5. Grooming scissors as recited in claim 4, wherein said second distal end has a width that is at least about 50 percent of the average width of the second blade measured between the second pivot point and the second distal end.
